(19) United States
(12) Patent Application Publication
(10) Pub. No.: US 2011/0093397 A1
(43) Pub. Date: Apr. 21, 2011

(54) ANTI-PHISHING SYSTEM AND METHOD INCLUDING LIST WITH USER DATA

(76) Inventors: Mark Carlson, Half Moon Bay, CA (US); Patrick Faith, Pleasanton, CA (US)

(21) Appl. No.: 12/905,686

(22) Filed: Oct. 15, 2010

Related U.S. Application Data
(60) Provisional application No. 61/252,484, filed on Oct. 16, 2009.

(51) Int. Cl. G06Q 20/00

(52) U.S. Cl. 705/67

(57) ABSTRACT

A server computer is disclosed. It comprises a processor and a computer readable medium coupled to the processor. The computer readable medium comprises code executable by the processor for implementing a method comprising: (i) receiving a request to conduct a transaction, (ii) providing a user interface to a user in response to the request, wherein the user interface includes a list of candidate identification tokens, wherein the list of candidate identification tokens includes an authentic identification token and one or more non-authentic identification tokens, wherein the authentic identification token is associated with a user account.

### CROSS-REFERENCES TO RELATED APPLICATIONS

This application claims benefit under 35 U.S.C. §119(e) of U.S. provisional patent application No. 61/252,484, entitled “Anti-Phishing System and Method Including List With User Data,” filed Oct. 16, 2009, the entire disclosure of which is incorporated herein by reference for all purposes.

### BACKGROUND

In recent years, online transactions have grown exponentially. Many of these transactions involve the purchase of goods and/or services. Online transactions may also involve, for example, the transfer of funds from one account to another.

One major area of concern with regard to online transactions is security. For instance, “phishing” scams have become a serious security threat. In a typical phishing scam, a user is lured into visiting a fake website, and into providing sensitive information such as passwords, account numbers, social security numbers, and the like. In general, the user believes that the website is legitimate because the site employs interfaces, logos, and colors similar to those of reputable online service providers.

In addition to phishing scams, web robots or “bots” pose another security problem. Bots are typically automated software programs that access various websites and attempt to break into user accounts. Bots typically gain access to user accounts through brute force attacks. For instance, most bots repeatedly enter guesses for a user's username and password until eventually making the correct guess.

What is needed is a system that can indicate to users that a particular website is legitimate while also deterring bots from fraudulently accessing user accounts. In addition, it would be desirable to improve the speed and convenience of conducting secure transactions. Embodiments of the present invention address these problems and other problems individually and collectively.

### BRIEF SUMMARY

Embodiments of the present invention relate to anti-phishing techniques that use real or authentic user data in combination with candidate user data to determine the identity of a user and also to determine the appropriate user account a user wishes to use to make a payment. In certain embodiments, authentic user data may include an identification token associated with a user account, such as a user payment card account. Examples of identification tokens can be account number segments such as the last four digits of a credit, prepaid, or debit card account number. One of ordinary skill in the art would recognize, however, that identification tokens may be embodied in any suitable manner. For instance, identification tokens may be user phrases, unique user information, pin number segments, images (e.g., pictures), sounds, payment card colors, and the like. Illustratively, an identification token may be a picture of the owner of a user account.

Embodiments of the present invention provide a user interface to a user in response to a request to conduct a transaction. The user interface includes a dropdown list including candidate identification tokens. For example, a dropdown list may include ten, four digit candidate identification tokens. The ten, four digit candidate identification tokens can include one authentic four digit number that is associated with a user's payment card account, and nine non-authentic four digit numbers that are not associated with the user's payment card account. The user interface may additionally ask a user to select the four digit number that is associated with the payment card that the user wants to use to make a payment.

Embodiments of the present invention improve the security of online transactions and user information. In particular, by providing a list that includes an authentic identification token, embodiments of the present invention allow a user to recognize that a website is legitimate (i.e. a fake website would not provide an authentic identification token). The user additionally does not need to enter his or her payment card account information in order to make a payment. As a result, the user is protected from having his or her sensitive account information being intercepted by spyware. Furthermore, by providing a list that includes non-authentic identification tokens, embodiments make it more difficult for bots to access user accounts.

Embodiments of the present invention also improve the speed and convenience of performing a transaction. In particular, embodiments permit a user, in one step, to (1) determine whether a website is legitimate, (2) authenticate himself or herself, and (3) select the payment card account that he or she wants to use to pay for a good or service, or to transfer money.

One embodiment of the invention is directed to a method. The method includes receiving a request to conduct a transaction, providing a user interface to a user in response to the request, wherein the user interface includes a list of candidate identification tokens, wherein the list of candidate identification tokens includes an authentic identification token and one or more non-authentic identification tokens, wherein the authentic identification token is associated with a user account.

Another embodiment of the invention is directed to a server computer comprising a processor and a computer readable medium coupled to the processor. The computer readable medium can comprise code executable by a processor for implementing a method comprising: (i) receiving a request to conduct a transaction, (ii) providing a user interface to a user in response to the request, wherein the user interface includes a list of candidate identification tokens, wherein the list of candidate identification tokens includes an authentic identification token and one or more non-authentic identification tokens, wherein the authentic identification token is associated with a user account.

These and other details regarding embodiments of the invention are provided below.

### BRIEF DESCRIPTION OF THE DRAWINGS

FIG. 1 shows an anti-phishing system, according to a first embodiment of the invention.

FIG. 2 shows a flow chart illustrating the steps involved in processing a money transfer transaction and authenticating a user, according to a first embodiment of the invention.

FIG. 3 shows an anti-phishing system, according to a second embodiment of the invention.

FIG. 4 shows a flow chart illustrating the steps involved in processing a purchase transaction and authenticating a user, according to a second embodiment of the invention.

FIG. 5 shows a first authentication screen, according to embodiments of the invention.

FIG. 6 shows a second authentication screen, according to embodiments of the invention.

FIG. 7 shows a system according to embodiments of the invention.

### DETAILED DESCRIPTION

One embodiment of the present invention is directed to a method. In the method, an authentication module uses anti-phishing techniques to authenticate a user who wishes to conduct a money transfer transaction. In order to authenticate the user, the authentication module operates an authentication server computer, which generates a list of candidate identification tokens. The list may include both authentic and non-authentic identification tokens. The authentic identification token may be associated with a particular user payment card account, such as a user credit card account. For example, the authentic identification token may be a segment of the user credit card account number, such as the account number's last four digits. The non-authentic identification tokens may be randomly generated or selected. Upon generating the list of candidate identification tokens, the authentication server computer presents the list to the user and asks the user to select the candidate identification token associated with the payment card account the user wants to use for the money transfer transaction. If the user selects the authentic identification token, the money transfer transaction process can be initiated (using the payment card account associated with the selected authentic identification token). The selection of the authentic identification token can correspond to the payment card that will be used to conduct the transaction. For example, after selecting the authentic identification token, an authorization request message can be generated by a financial transactions portal and can then be sent (e.g., transmitted) to an issuer. After receiving the authorization request message, the issuer sends an authorization response message back to the financial transactions portal indicating whether the money transfer transaction is approved or denied. The financial transactions portal may provide the authorization response message to the user.

Another embodiment of the present invention is also directed to a method. In the method, an authentication module uses anti-phishing techniques to authenticate a user who wishes to conduct a purchase transaction. For instance, the user may wish to buy goods and/or services from an online merchant. In order to authenticate the user, the authentication module operates an authentication server computer, which generates a list of candidate identification tokens. The list may include both authentic and non-authentic identification tokens. The authentic identification token may be associated with a particular user payment card account, such as a user credit card account. For example, the authentic identification token may be a segment of the user credit card account number, such as the account number's last four digits. The non-authentic identification tokens may be randomly generated or selected. Upon generating the list of candidate identification tokens, the authentication server computer presents the list to the user and asks the user to select the candidate identification token associated with the payment card account the user wants to use for the purchase transaction. If the user selects the authentic identification token, the purchase transaction process can be initiated (using the payment card account associated with the selected authentic identification token). The selection of the authentic identification token can correspond to the payment card that will be used to conduct the transaction. For example, after selecting the authentic identification token, an authorization request message can be generated by the merchant and can then be sent (e.g., transmitted) to an issuer. After receiving the authorization request message, the issuer sends an authorization response message back to the merchant indicating whether the purchase transaction is approved or denied. The merchant may provide the authorization response message to the user.

It should be appreciated that an identification token may be embodied in any suitable manner. For instance, identification tokens may be user phrases, unique user information, account number segments, pin number segments, images (e.g., pictures), sounds, payment card colors, last large transaction amounts, and the like. Illustratively, an identification token may be a picture of the owner of an account. During authentication, a user may be presented with a list of ten images (e.g., ten picture portraits of different people) and asked to choose the image that corresponds to a picture of the account owner. As another example, a user may be presented with 15 sounds (e.g., 15 segments of different songs), and asked to choose the sound associated with an account. In some embodiments, an identification token may be based on information about a user or a user's account that is available to an issuer, acquirer, financial transactions portal, merchant, payment processing network, and/or the like. The information may also be known by the user and need not be provided by the user in advance to an issuer, acquirer, financial transaction portal, merchant, payment processing network, and/or the like.

Embodiments of the present invention provide several advantages. First, providing a list of identification tokens including both authentic and non-authentic tokens makes it more difficult for bots to access user payment card accounts and initiate fraudulent transactions. For instance, in a list including one authentic token and nine non-authentic tokens, a bot has only a ten percent chance of selecting the correct token. Furthermore, when such a list is paired with another authentication challenge, such as password field, the probability of a bot fraudulently initiating a transaction becomes extremely small.

Embodiments of the present invention further permit a user to verify that a website is legitimate without needing to provide sensitive information. More specifically, if a website presents a user with a list containing an authentic identification token, the user can immediately determine that the website is legitimate (i.e. a fake website would not provide a list including an authentic identification token). Additionally, the user need only provide relatively non-sensitive information, such as a username or email address, in order to be presented with the list.

Embodiments of the present invention further protect users from spyware and the like. In particular, by selecting an authentic identification token from a list of candidate identification tokens, the user can also choose the payment card account he or she wants to use for a transaction without ever needing to actually enter any account information. Because the user never directly inputs any payment card account information, spyware and other malicious software cannot intercept such information.

Embodiments of the present invention further provide added convenience and speed to an online transaction. In particular, by selecting an authentic identification token, such as a credit card account number segment, a user can be authenticated and initiate processing of a transaction in the same step. The user does not need to separately provide his or her credit card account number.

Exemplary systems and methods are described in further detail below.

### I. Exemplary Systems

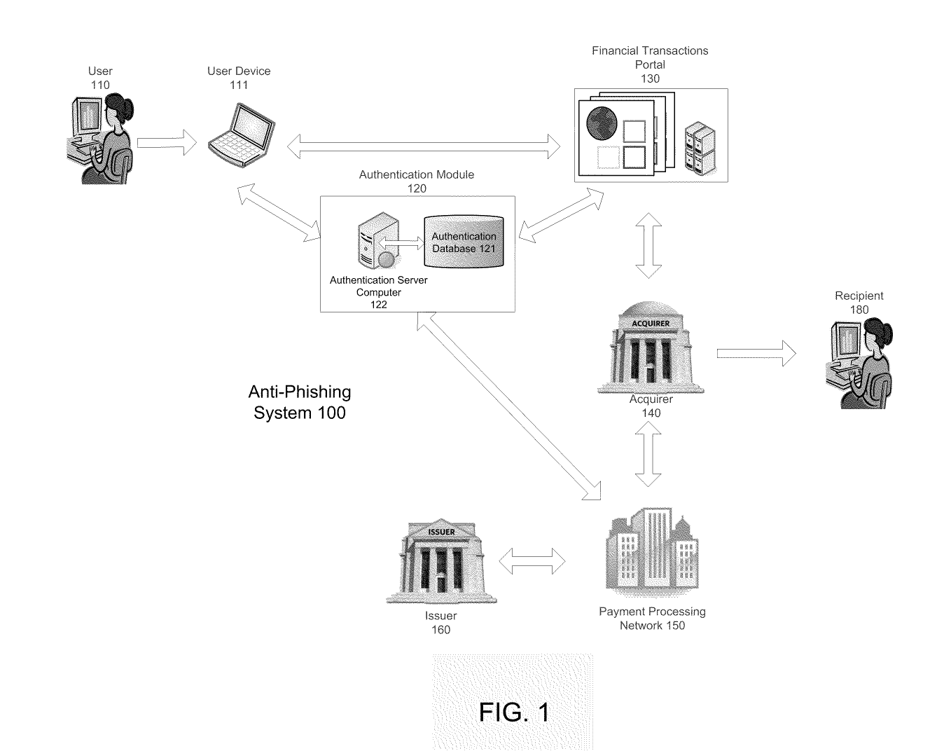

A system according to a first embodiment of the invention is shown in FIG. 1. In particular, FIG. 1 shows an anti-phishing system 100.

The anti-phishing system 100 may include a plurality of users, user devices, recipients, financial transactions portals, authentication modules, acquirers, and issuers. For example, the anti-phishing system 100 may include a first financial transactions portal and a first acquirer associated with the first financial transactions portal. The anti-phishing system 100 may additionally include a second financial transactions portal and a second acquirer associated with the second financial transactions portal.

In a typical money transfer transaction, the user 110 may wish to transfer money to the recipient 180 using financial transactions portal 130. The user 110 may access financial transactions portal 130 using user device 111, such as a laptop computer. Other examples of user devices are provided below. The financial transactions portal 130 may be in operative communication with the acquirer 140. The acquirer 140 may be in operative communication with the payment processing network 150 and with the issuer 160 (via the payment processing network 150). The issuer 160 may issue a portable device (not shown), such as a credit card, to the user 110. The portable device may further be associated with the user's 110 payment card account.

The authentication module 120 may be in operative communication with the user 110 via user device 111. The authentication module 120 may further be in operative communication with payment processing network 150 and financial transactions portal 130. Although the authentication module 120 is shown as being separate from the financial transactions portal 130, the payment processing network 160, the acquirer 140, and the issuer 160, it is understood that the authentication module 120 may be a part of any of the foregoing entities in other embodiments of the invention. In some cases, it is desirable to include the authentication module 120 in the payment processing network 150 since the payment processing network 150 is securely located between the issuer 160 and the acquirer 140.

In certain embodiments, the various entities shown in FIG. 1 may communicate through any suitable communication medium including networks such as the Internet.

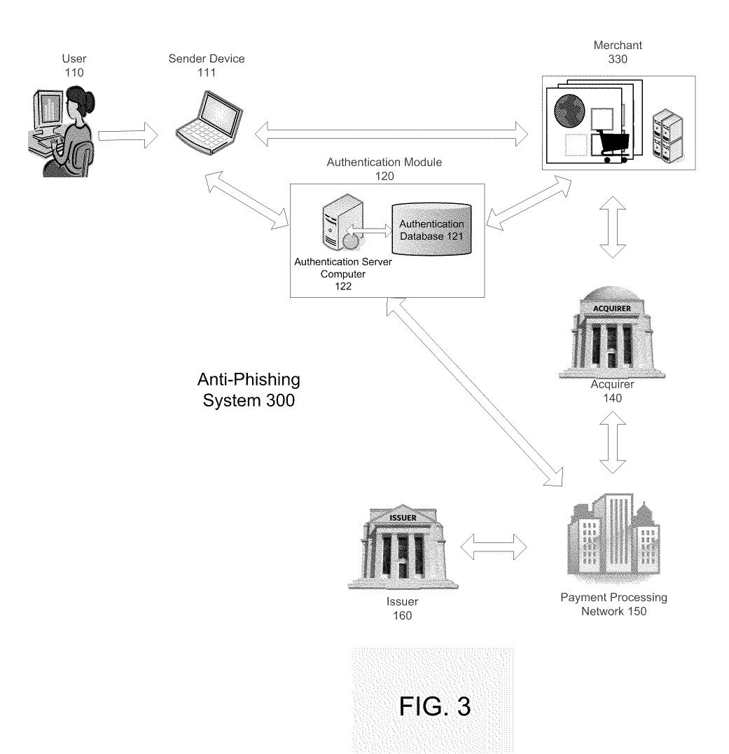

A system according to a second embodiment of the invention is shown in FIG. 3. In particular, FIG. 3 shows an anti-phishing system 300.

The anti-phishing system 300 may include a plurality of users, user devices, recipients, merchants, authentication modules, acquirers, and issuers. For example, the anti-phishing system 300 may include a first merchant and a first acquirer associated with the first merchant. The anti-phishing service 300 may additionally include a second merchant and a second acquirer associated with the second merchant.

In a typical purchase transaction, the user 110 may wish to buy goods and/or services from the merchant 330 using user device 111. The merchant 330 may be in operative communication with the acquirer 140. The acquirer 140 may be in operative communication with the payment processing network 150 and with the issuer 160 (via the payment processing network 150). The issuer 160 may issue a portable device (not shown), such as a credit card, to the user 110. The portable device may further be associated with the user's 110 payment card account.

The authentication module 120 may be in operative communication with the user 110 via user device 111. The authentication module 120 may further be in operative communication with payment processing network 150 and merchant 330. Although the authentication module 120 is shown as being separate from the merchant 330, the payment processing network 160, the acquirer 140, and the issuer 160, it is understood that the authentication module 120 may be a part of any of the foregoing entities in other embodiments of the invention. In some cases, it is desirable to include the authentication module 120 in the payment processing network 150 since the payment processing network 150 is securely located between the issuer 160 and the acquirer 140.

In certain embodiments, the various entities shown in FIG. 3 may communicate through any suitable communication medium including networks such as the Internet.

As used herein, a “user” is typically an individual, a business, or an agent acting on behalf of an individual or business wishing to initiate a transaction. For example, a user may wish to conduct a transaction such as transferring money from one account to another. As a second example, a user may wish to conduct a purchase transaction in order to buy goods and/or services from a merchant.

A user may maintain a payment card account with an issuer. The user payment card account may be a credit card, debit card, or prepaid card account. The user payment card account may additionally be associated with a unique account identifier. The account identifier, for instance, may be a sixteen digit account number.

As used herein, a “recipient” can be an intended receiver of funds transferred in a money transfer transaction. A recipient may be an individual, a business, or an agent acting on behalf of an individual or business. In some instances, a recipient may be the same individual or entity as the user. For instance, a user may wish to transfer money from one of his or her user payment card accounts to another.

As used herein, a “merchant” can refer to any suitable entity or entities that conduct a purchase transaction with a user. A merchant may use any suitable method to conduct a transaction. For example, a merchant may use an e-commerce business to allow a user to purchase goods and/or services over the Internet.

As used herein, a “financial transactions portal” can refer to any suitable entity or entities that can facilitate a money transfer transaction for a user. A financial transactions portal may also facilitate other transactions for a user, including purchase transactions. A financial transactions portal may use any suitable method to facilitate transactions. For example, a financial transactions portal may use an e-commerce business to allow money transfer transactions to be conducted over the Internet. A financial transactions portal may be part of an acquirer, a payment processing network, an issuer, or a separate entity in communication with any combination of a payment processing network, acquirer, or issuer.

As used herein, an “acquirer” can refer to any suitable entity that has an account with either an entity that operates a financial transactions portal or merchant. In some embodiments, an issuer may also be an acquirer.

As used herein, a “payment processing network” refers to a network of suitable entities that has information related to an account associated with a portable device. This information includes data associated with the account on the portable device such as profile information, data, and other suitable information.

A payment processing network may have or operate a server computer and may include a database. The database may include any hardware, software, firmware, or combination of the preceding for storing and facilitating retrieval of information. Also, the database may use any of a variety of data structures, arrangements, and compilations to store and facilitate retrieval of information. The server computer may be coupled to the database and may include any hardware, software, other logic, or combination of the preceding for servicing the requests from one or more client computers. The server computer may use any of a variety of computing structures, arrangements, and compilations for servicing the requests from one or more client computers.

A payment processing network may include data processing subsystems, networks, and operations used to support and deliver authorization services, exception file services, and clearing and settlement services. An exemplary payment processing network is VisaNet™. Networks that include VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services. A payment processing network may use any suitable wired or wireless network, including the Internet.

As used herein, an “issuer” can refer to any suitable entity that may open and maintain an account associated with a user. Some examples of issuers may include a bank, a business entity such as a retail store, or a governmental entity. In many cases, an issuer may also issue, to the user, a portable device associated with the payment card account of the user. A portable device may be, for instance, a credit card.

As used herein, a “recipient's issuer” can refer to any suitable entity that may open and maintain an account associated with a recipient. Some examples of issuers may include a bank, a business entity such as a retail store, or a governmental entity. In many cases, a recipient's issuer may also issue, to the recipient, a portable device associated with the payment card account of the recipient. A portable device may be, for instance, a credit card.

As used herein, an “authentication module” can refer to any suitable entity or entities that authenticate users and process transaction information. An authentication module may be part of a payment processing network, an acquirer, an issuer, a financial transactions portal, a merchant, or a separate entity in communication with any combination of a payment processing network, acquirer, issuer, financial transactions portal, or merchant. An authentication module may include an authentication server computer and an authentication database.

As used herein, an “authentication server computer” may be a powerful computer or cluster of computers. For example, an authentication server computer can be a large mainframe, a minicomputer cluster, or a group of server computers functioning as a unit. In one example, an authentication server computer may be a database server coupled to a web server. The web server may serve a plurality of web pages. In another example, an authentication server computer may be a database server coupled to an applications server. The applications server may provide data to client applications. An authentication server computer may include a computer readable medium (CRM) and a processor coupled to the CRM, wherein the computer readable medium comprises code executable by the processor for implementing a method comprising: (i) receiving a request to conduct a transaction, (ii) providing a user interface to a user in response to the request, wherein the user interface includes a list of candidate identification tokens, wherein the list of candidate identification tokens includes an authentic identification token and one or more non-authentic candidate identification tokens, wherein the authentic identification token is associated with a user account.

As used herein, an “authentication database” may be in the form of one or more server computers for storage of data. It may also be in the form of one or more electronic storage units (stand alone hard drives) capable of storing electronic data. An authentication database may store a plurality of user profiles containing user data such as payment card account numbers, usernames, passwords, user personal information, email addresses, phone numbers, home addresses and the like. In certain embodiments, the authentication database may be a part of the payment processing network 150 or issuer 160 instead of the authentication module 120.

As used herein, a “user device” may be a user computer, a mobile device, and the like. A user computer may be a personal desktop or a laptop computer. The user computer may run an operating system such as Microsoft Windows™ or Apple Mac OSX™. The user computer may further have a suitable browser such as Internet Explorer™, Firefox™, or Safari™. A mobile device may include cellular phones, smartphones, personal digital assistants (PDAs), pagers, tablet devices, and the like. The mobile device may additionally run an operating system such as Android™ or Symbian™ and also have a suitable Internet browser. A mobile device may additionally run client applications that can communicate with and receive data from an application server.

### II. Method

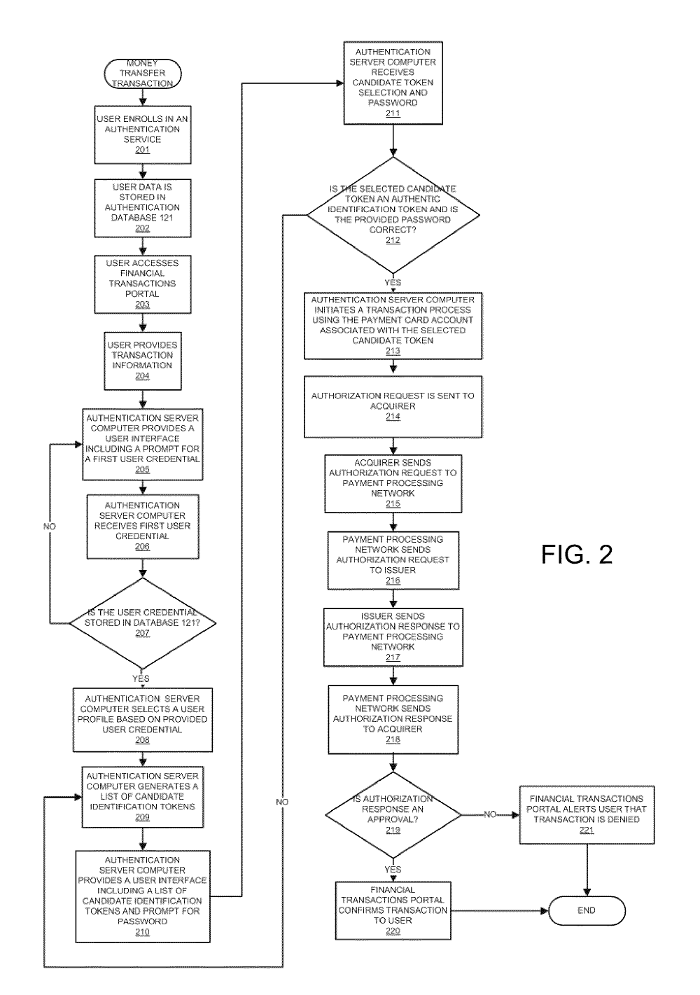

Methods according to embodiments of the invention can be described with respect to FIGS. 2, 4, 5, and 6.

### A. Money Transfer Transactions

FIG. 2 is a flow chart of a first embodiment that illustrates authentication of a user and processing of a money transfer transaction.

### 1. Authentication Service Enrollment

In some embodiments of the present invention, the user 110 may enroll in an authentication service provided by the anti-phishing system 100 through multiple ways (step 201 in FIG. 2). In some embodiments, the user 110 may be enrolled automatically by the issuer 160 that issues the payment card account. For instance, at the time the user 110 is issued his or her credit card account and corresponding credit card, the user 110 may additionally be enrolled in the authentication service. Enrollment may be done in a batch mode, by file delivery from issuer 160, or by file delivery from some other party.

In other embodiments, the issuer 160 or the payment processing network 150 may provide the authentication service as an option to the user 110 at which time the user 110 may enroll in the authentication service either by contacting a customer service representative (provided either by the issuer 160 or payment processing network 150) over the phone, or by accessing an enrollment website. In certain embodiments, the website may be hosted by one entity but can redirect the user 110 to a site hosted by another entity.

During the enrollment process, the user 110 provides information that can be used by the anti-phishing system 100 during authentication and processing of a transaction. The user may provide such information either by filling out an online application provided by the enrollment website or by contacting a customer service representative (e.g., using the phone). The user 110 may later access the website or contact a customer service representative to change the information provided at any time.

Information provided by the user 110 may include user payment card account numbers, a username, a password, user personal information, email addresses, home address, phone numbers, and the like.

In certain embodiments, information provided by the user 110 is stored as user data in an authentication service user profile in authentication database 121 (step 202 in FIG. 2). In some embodiments, the authentication database 121 may store a plurality of authentication service user profiles.

In certain embodiments, enrollment information provided by the user 110 may be initially received by the payment processing network 150. In embodiments where the authentication module 120 is not a part of the payment processing network 150, the payment processing network 150 may synchronize user information with the authentication module 120 over a communications medium, such as the Internet. For example, if a new user enrolls in the authentication service, the payment processing network 150 may provide the user's information to the authentication module 120. The information may subsequently be stored in authentication database 121.

### 2. Initiating a Transaction Request

In a typical money transfer transaction, the user 110 makes a request to conduct a transaction by accessing the financial transactions portal 130 using a computer program, such as a web browser or mobile device application, on user device 111 (step 203 in FIG. 2). The request may simply be indicated as an intent to conduct a transaction by the user 110. The request may be at the user's own initiative or may be in response to a request from another party such as the operator of the financial transactions portal 130.

In some embodiments, the user 110 provides, to the financial transactions portal 130, information for the transaction that the user 110 wants to conduct (step 204 in FIG. 2). In some embodiments, the user 110 may indicate the type of transaction to be conducted. For example, the user 110 may choose to conduct a money transfer transaction in order to send funds to the recipient 180. The user 110 may additionally choose the method for delivering the funds. For instance, the user may indicate, in a money transfer, that the acquirer 140 deliver funds directly to the recipient's 180 credit card, debit card, or bank account. The user 110 may alternatively choose to have the acquirer 140 issue a check, cash, or prepaid card to the recipient 180. In some embodiments, the user 110 may elect to have funds delivered through more than one method. For instance, the user 110 may wish to have 100 dollars sent to the recipient 180. The user 110 may elect to have 50 dollars sent directly to the recipient's 180 credit card account and the remaining 50 dollars transferred to the recipient 180 in the form of a prepaid card.

In providing transaction information, the user 110 may also provide the amount of money to be transferred, the currency, the name of the recipient 180, the username of the recipient 180, the email address of the recipient 180, the home address of the recipient 180, the account number of the recipient's 180 payment card account, and the like. In other embodiments, money can be transferred to an alias associated with the recipient 180. Examples of aliases may include phone numbers, nicknames or e-mail addresses associated with the recipient 180.

In some embodiments, the financial transactions portal 130, upon receiving information for the transaction from the user 110, may validate the provided information. For instance, in the case of a money transfer transaction, the financial transactions portal 130 may determine whether the payment card account number for the recipient 180 is in the proper format and/or a valid account number.

### 3. User Authentication

In certain embodiments, the financial transactions portal 130 may initiate a communications link between the user 110 and authentication module 120. For instance, in certain embodiments, the financial transactions portal 130 may redirect the user's 110 web browser to access the authentication module 120. In some embodiments, authentication module 120 may be integrated into the operation of the financial transactions portal 130 so that the money transfer transaction appears seamless to the user 110. For instance, a graphical user interface provided by the authentication module 120 may be integrated with an interface provided by the financial transactions portal 130. In certain embodiments, the authentication module 120 may be a part of the financial transactions portal 130. As a result, the same server computer that authenticates the user 110 may additionally receive the transaction information from the user 110. In other embodiments, the financial transactions portal 130 may send the transaction information to the authentication module 120.

a. Receiving a first user credential

In certain embodiments, the authentication module 120 includes an authentication server computer 122. Upon receiving a request to conduct a transaction, a processor (which executes code on a computer readable medium) in the authentication server computer 122 may provide the user 110 with a graphical user interface (step 205 of FIG. 2). The graphical user interface may be presented in any suitable format for presentation to the user. For instance, the graphical user interface may be coded in HTML and JavaScript for presentation to the user 110 within a web browser running on a laptop computer. As a second example, the graphical user interface may be coded according to the specifications required by a client application running on a mobile device such as an Apple iPhone™ or iPad™

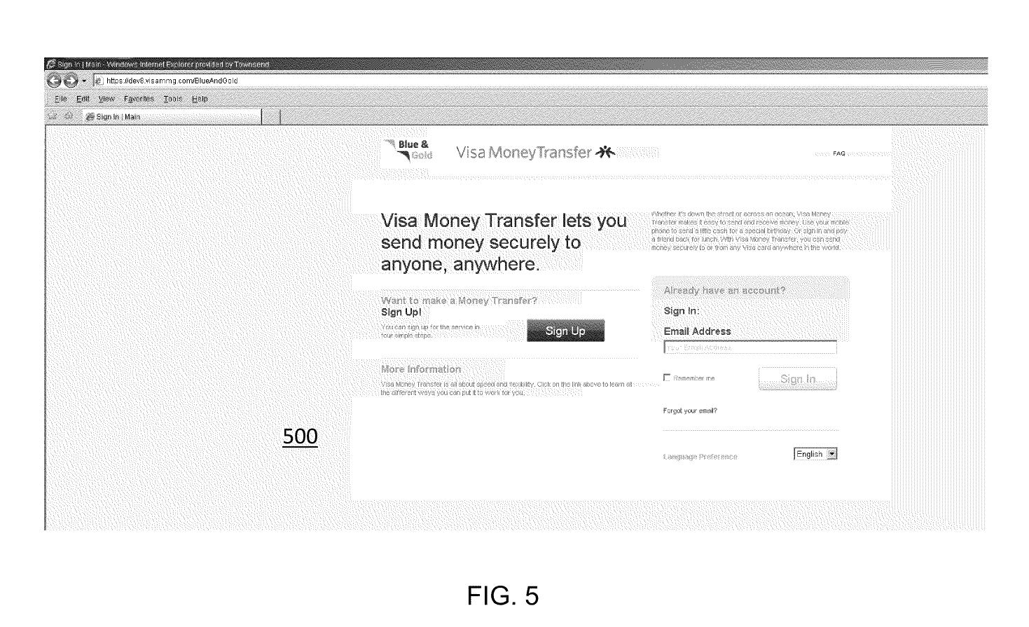

In certain embodiments, the graphical user interface may present a first authentication screen including a prompt asking the user 110 to provide a first user credential. The first user credential may be a username or email address associated with the user's 110 authentication service user profile. For instance, FIG. 5 shows a first authentication screen of the graphical user interface including a prompt asking a user to “Sign-In” by providing an email address. In some embodiments, the graphical user interface may ask that the user provide more than one user credential. For example, the user interface may include a prompt asking the user 110 to provide both a username and email address associated with the user's 110 authentication service user profile.

Upon receiving the one or more user credentials (step 206 of FIG. 2), a processor (which executes code on a computer readable medium) in the authentication server computer 122 accesses database 121. In certain embodiments, the authentication database 121 may be a part of the authentication module 120, as shown in FIG. 1. In other embodiments, the authentication database 121 may be a part of the payment processing network 150 or issuer 160. In these embodiments, the authentication server computer 122 may access the database 121 through a communications link.

Upon accessing the authentication database 121, the authentication server computer 122 determines if a match exists for the user credentials among the authentication service user profiles stored in the database 121 (steps 207 of FIG. 2). If a matching user profile is not located, the authentication server computer 122 may ask the user 110 to make another attempt at providing the one or more user credentials. If a matching user profile is located, the authentication server computer 122 selects the matching profile (steps 208 of FIG. 2). The selected profile may include user data such as the user's 110 payment card account numbers, username, password, personal information, home address, phone numbers, email addresses, and the like. The user data comprising the profile may have been previously provided by the user 110 and/or provided by the issuer 160, for example, at the time of user enrollment in the authentication service provided by the anti-phishing system 100.

b. Generating a List of Candidate Identification Tokens

Upon selecting a matching profile, a processor (which executes code on a computer readable medium) in the authentication server computer 122 uses the user data comprising the selected profile to generate a list of candidate identification tokens (step 209 of FIG. 2). In some embodiments, the authentication server computer 122 may generate the list based on the payment card account numbers associated with the selected user profile.

The list of candidate identification tokens may include any suitable number of tokens. For instance, the authentication server computer 122 may generate a list including ten candidate identification tokens. In some embodiments, each candidate identification token may additionally be in the same format. For instance, all candidate identification tokens in a list may be formatted to only include numbers and be exactly four digits in length. Suitable identification tokens may be in the form of numbers, letters, symbols, etc.

In certain embodiments, the list of candidate identification tokens may include both authentic tokens associated with the user's 110 payment card account and non-authentic tokens not associated with the user's 110 payment card account.

In some embodiments, an authentic identification token may be a segment or portion of one of the user's 110 actual payment card account numbers. For instance, the authentication server computer 122 may generate an authentic identification token by selecting the last four digits of a credit card, debit card, or prepaid card account number. In certain embodiments, the list of candidate identification tokens may include only one authentic identification token. In other embodiments, the list of candidate identification tokens may include more than one authentic identification token. For instance, the user's 110 authentication service user profile may include two different credit card accounts. The account number for the first credit card account may be “1234 5000 0001 2345.” The account number for the second credit card account may be “5432 1000 0005 4321.” As a result, the list of candidate identification tokens would include two authentic identification tokens: “2345” and “4321.”

In certain embodiments, the authentication server computer 122 may generate or select the non-authentic identification tokens in any suitable manner.

In some embodiments, a processor (which executes code on a computer readable medium) in the authentication server computer 122 may randomly (or pseudo-randomly) generate one or more non-authentic identification tokens. The generated non-authentic identification tokens may be in the same format as an authentic identification token. For instance, if an authentic identification token is made up of four numbers, the non-authentic identification tokens may also be made up of four numbers.

After generating a non-authentic identification token, the authentication server computer 122 may determine whether the generated identification token is a duplicate of an authentic identification token or of another non-authentic identification token. If the token is a duplicate, the authentication server computer 122 may generate a replacement non-authentic identification token in order to avoid having two identical identification tokens. In other embodiments, the authentication server computer 122 may apply rules preventing a duplicate identification token from being generated.

In some embodiments, a processor (which executes code on a computer readable medium) in the authentication server computer 122 may randomly (or pseudo-randomly) select one or more non-authentic identification tokens from a pool of non-authentic identification tokens stored in database 121. For instance, the authentication server computer 122 may select nine non-authentic identification tokens from a pool of one hundred identification tokens. In some embodiments, the non-authentic identification tokens in the pool are in the same format as the authentic identification token. In other embodiments, the authentication server computer 122 may modify the non-authentic identification tokens to be in the same format as an authentic identification token. For instance, the pool of non-authentic identification tokens may include one hundred sixteen digit numbers. If the authentic identification token is made up of four numbers, the authentication server computer 122 may truncate the non-authentic identification tokens to also be made up of four numbers.

Upon selecting a non-authentic payment card identification token, the authentic server computer 122 may determine whether the selected token is a duplicate of an authentic identification token or of another selected non-authentic identification token. If a duplicate is found, the authentication server computer 122 may select a replacement non-authentic identification token. In other embodiments, the authentication server computer 122 may apply rules preventing a duplicate identification token from being selected.

In certain embodiments, the list of identification tokens may include a greater number of non-authentic identification tokens than real identification tokens. For instance, the list of identification tokens may include one authentic identification token and nine non-authentic identification tokens. As another example, the list of identification tokens may include two authentic identification tokens and fifteen non-authentic identification tokens. By generating a list of identification tokens with a greater number of non-authentic tokens than authentic tokens, embodiments are able to reduce the probability that a bot selects an authentic identification token.

In certain embodiments, the position of the identification tokens within the list of candidate identification tokens may change periodically. For example, the user 110 may initiate a first transaction. During authentication, the authentic identification token may appear in the second position within the list. The user 110 may later initiate a second, different transaction. During authentication for the second transaction, the authentic identification token may appear in the fifth position within the list. In another example, the position of the authentic identification token within the list may vary between the different authentication attempts of a single transaction. For instance, during a first authentication attempt for a transaction, the authentic identification token may appear in the second position within the list. The user 110 may subsequently select a non-authentic identification token. As a result, the user 110 may be asked once more to select the authentic identification token. During the second authentication attempt, the authentic identification token may appear in the fifth position within the list.

c. Selecting a Candidate Identification Token

Upon generating the list of candidate identification tokens, the authentication server computer 122 may present a second authentication screen of the graphical user interface to the user 110 (step 210 of FIG. 2).

The second authentication screen may include the list of candidate identification tokens generated by the authentication server computer 122. The list of candidate identification tokens may be provided in any suitable manner, such as in the form of a dropdown list, radio button list, selection form, or the like.

Upon being presented with the list, the user 110 is asked to select the identification token associated with the payment card account that the user 110 wishes to use for the transaction. In some embodiments, the second authentication screen may additionally include a text field for the user to enter a password.

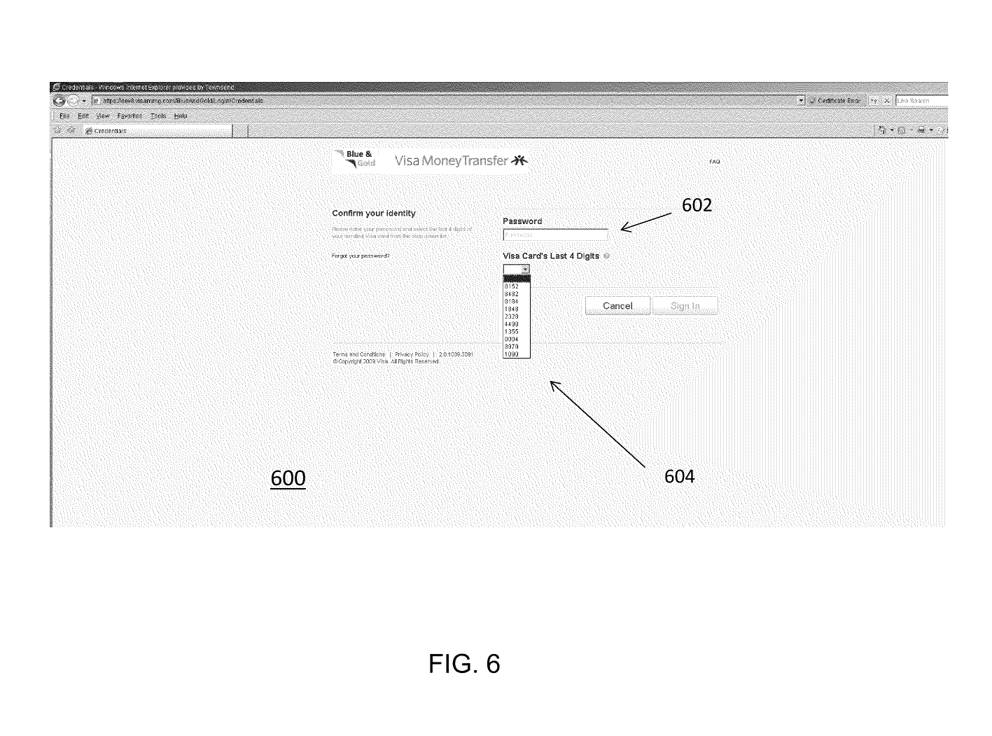

FIG. 6 shows an example of the second authentication screen provided by the graphical user interface. The second authentication screen includes a text field 602 for the user to enter a password. The screen further includes a dropdown list 604 of candidate identification tokens. The candidate identification tokens in FIG. 6 represent candidate payment card account number segments. In particular, the tokens in the list represent the final four digits of a credit card account number. The list of payment card account number segments includes an authentic account number segment that is associated with the user's 110 credit card account number.

Upon receiving the user's 110 candidate identification token selection and password, the authentication server computer 122 determines if the selection and password are correct (step 211 of FIG. 2). If the user 110 selects a non-authentic identification token or enters an incorrect password, the authentication server computer 122 may indicate to the user 110 that the selection or password is incorrect. In some embodiments, the authentication server computer 122 may additionally permit the user 110 to make a subsequent authentication attempt. In certain embodiments, the number of subsequent authentication attempts may be limited to a certain number. For example, the user 110 may be limited to only three authentication attempts. In other embodiments, the authentication server 122 may not permit the user 110 to perform a subsequent authentication attempt.

### 4. Initiating the Transaction Process

Once the authentication server computer 122 receives an authentic identification token selection and a correct password (step 212 of FIG. 2), the authentication server computer 122 may initiate the transaction process using the payment card account number associated with the selected identification token (step 213 of FIG. 2). For example, if the user 110 selects the identification token “1234,” a transaction may be initiated using his or her payment card account number, which may be “0000 1111 0000 1234.” One of ordinary skill in the art would recognize that the selected identification token is associated with user's 110 payment card account because the token represents a segment of the payment card account number. Specifically, the token represents the final four digits of the payment card account number. As discussed, the transaction process may be initiated without the user 110 ever having to enter his or her payment account information.

Upon selecting the payment card account associated with the authentic identification token, a processor in the authentication server computer 122 or some other server computer may generate an authorization request message. In other embodiments, the authentication server computer 122 may indicate to the financial transactions portal 130 that an authorization request message is to be generated. A processor in the financial transactions portal 130 may, in response, generate the authorization request message.

The generated authorization request message may include, for example, the account number and expiration date associated with the user's 110 payment card account, a verification value (e.g., a CVV or card verification value), a service code, a transaction amount, and the like.

After the authorization request message is generated, a processor either in the authentication server computer 122 or in the financial transactions portal 130 forwards the authorization request message to the acquirer 140 (step 214 in FIG. 2). After receiving the authorization request message, the acquirer 140 sends the message to the payment processing network 150 (step 215 in FIG. 2). The payment processing network 150 then sends the authorization request message to the issuer 160 (step 216 in FIG. 2).

After the issuer 160 receives the authorization request message, the issuer 160 determines whether to approve or deny the transaction. Next, a processor in the issuer 160 generates an authorization response message indicating whether the transaction is approved or denied. The issuer 160 subsequently sends the authorization response message to the payment processing network 150 to indicate whether the transaction is approved or denied (step 217 in FIG. 2).

After the payment processing network 150 receives the authorization response message, it sends the authorization response message to the acquirer 140 (step 218 in FIG. 1). The acquirer 140, upon receiving the response message, sends the message to the financial transactions portal 130 (step 219 in FIG. 2), which indicates to the user 110 whether the transaction was approved or denied (steps 220 and 221 in FIG. 2).

At the end of the day, a clearing and settling process occurs. During the clearing process the acquirer 140 provides the issuer 160 information on the money transfer transaction. No money is exchanged during clearing. Clearing involves the exchange of data. The acquirer 140 provides data required to identify the user payment card account and provide the dollar amount for the money transfer transaction. When the issuer 160 receives this data, the issuer 160 posts the amount of the money transfer transaction as a draw against the user's 110 available credit and prepares to send payment to the acquirer 140. The second step is the actual exchange of funds to the acquirer 140. The issuer 160 sends a record of money that is being transferred from its account to that of the acquirer 140. From this account, the acquirer 140 provides funds to the recipient 180. Funds can be sent to the recipient 180 through different methods. For example, if the user 110 chooses to transfer funds to a recipient's credit card account, the acquirer 140 submits an original credit transaction via the payment processing network 150 to the recipient's 180 issuer. The result of the original credit transaction is an instruction to the recipient's 180 issuer to credit the credit card account of the recipient 180. Additional information regarding original credit transactions is described in U.S. patent application Ser. No. 10/926,652, the entire disclosure of which is incorporated herein by reference for all purposes.

### B. Purchase Transactions

FIG. 3 shows an anti-phishing system 300, according to a second embodiment of the invention. Anti-phishing system 300 includes many of the same elements as anti-phishing system 100 shown in FIG. 1. However, anti-phishing system 300 replaces the financial transactions portal 130 with the merchant 330.

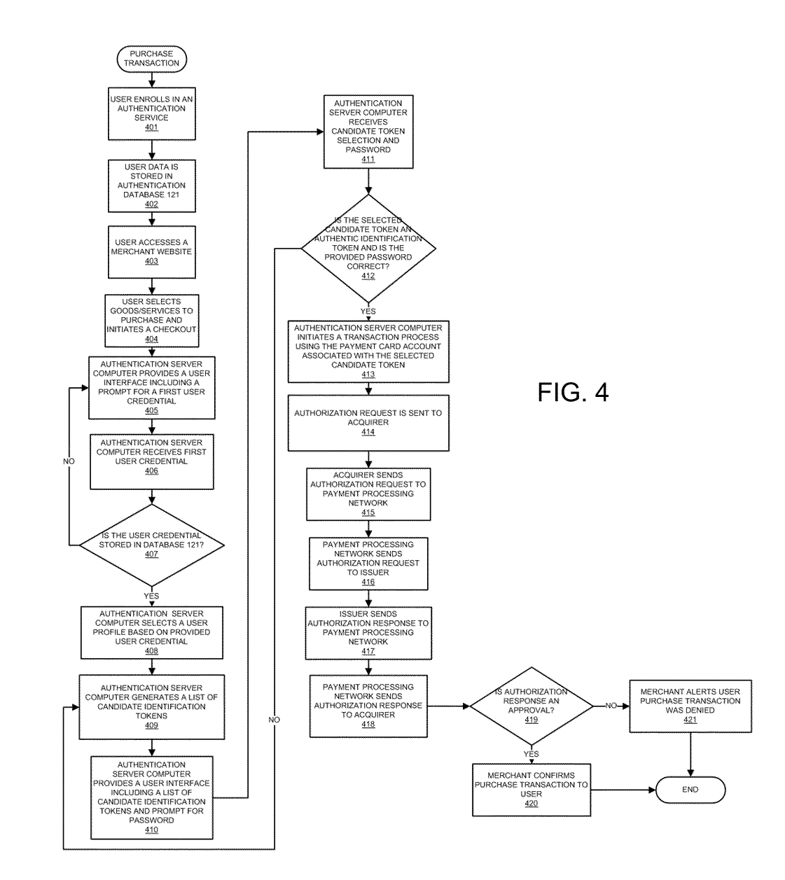

In this embodiment, the user 110 initiates a purchase transaction to buy goods and/or services from the merchant 330. FIG. 4 shows a flow chart illustrating the steps involved in processing a purchase transaction and authenticating a user. Steps 401-403 and 405-421 are similar to steps 201-203 and steps 205-221 respectively except that the merchant 330 replaces the financial transactions portal 130.

Step 404 differs in that instead of providing transaction information such as the recipient 180's account number, the user 110 selects the goods and/or services that he or she wishes to purchase. In certain embodiments, the user 110 may select the goods and/or services through, for example, an online cart system. After selecting the goods and/or services he or she wishes to buy, the user 110 initiates a checkout process. During the checkout process, the merchant 330 may automatically calculate the total purchase transaction amount. The user 110 may provide additional transaction information such as the user's 110 shipping address, preferred shipping method, and the like.

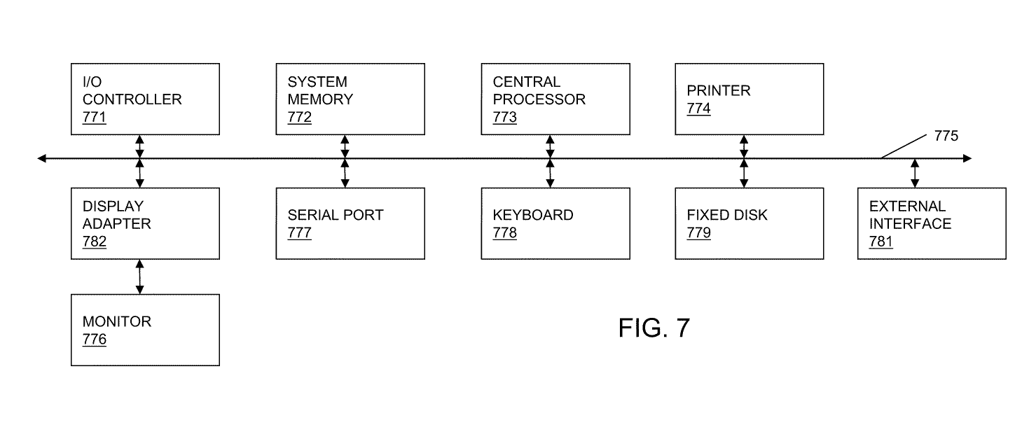

The various participants and elements in the described system diagrams (e.g., the computers, issuers, servers, etc. in FIGS. 1 and 3) may use any suitable number of subsystems to facilitate the functions described herein. Examples of such subsystems or components are shown in FIG. 7. The subsystems shown in FIG. 7 are interconnected via a system bus 775. Additional subsystems such as a printer 774, keyboard 778, fixed disk 779 (or other memory comprising computer-readable media), monitor 776, which is coupled to display adapter 782, and others are shown. Peripherals and input/output (I/O) devices, which couple to I/O controller 771, can be connected to the computer system by any number of means known in the art, such as serial port 777. For example, serial port 777 or external interface 781 can be used to connect the computer apparatus to a wide area network such as the Internet, a mouse input device, or a scanner. The interconnection via system bus allows the central processor 773 to communicate with each subsystem and to control the execution of instructions from system memory 772 or the fixed disk 779, as well as the exchange of information between subsystems. The system memory 772 and/or the fixed disk 779 may embody a computer-readable medium.

The software components or functions described in this application may be implemented as software code to be executed by one or more processors using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

The present invention can be implemented in the form of control logic in software or hardware or a combination of both. The control logic may be stored in an information storage medium as a plurality of instructions adapted to direct an information processing device to perform a set of steps disclosed in embodiments of the present invention. Based on the disclosure and teachings provided herein, a person of ordinary skill in the art will appreciate other ways and/or methods to implement the present invention.

In embodiments, any of the entities described herein may be embodied by a computer that performs any or all of the functions and steps disclosed. For example, any of the functions described for the authentication server computer may be performed by a processor in the authentication server computer, which may execute code on a computer readable medium. As a further example, any of the functions described for a user device may be performed by a processor in the user device, which may execute code on a computer readable medium.

Any recitation of “a”, “an” or “the” is intended to mean “one or more” unless specifically indicated to the contrary.

One or more features of the various embodiments described above, may be combined with other features of other embodiments in any suitable manner without departing from the scope of the invention.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One of ordinary skill in the art would further appreciate that any steps of the methods described herein may be performed in any order without departing from the scope of the invention.

What is claimed is:

1. A method comprising:
receiving a request to conduct a transaction; and,
providing a user interface to a user in response to the request, wherein the user interface includes a list of candidate identification tokens, wherein the list of candidate identification tokens includes an authentic identification token and one or more non-authentic identification tokens, wherein the authentic identification token is associated with a user account.

2. The method of claim 1 wherein the user's account is a payment card account.

3. The method of claim 2 wherein the authentic identification token is a segment of an account number associated with the user's account.

4. The method of claim 3 wherein each candidate identification token in the list of candidate identification tokens is a four digit number.

5. The method of claim 4 wherein the authentic candidate identification token is the last four digits of an account number associated with the user account.

6. The method of claim 1 further comprising receiving a candidate identification token selection and determining if the selected candidate identification token is the authentic identification token.

7. The method of claim 6 further comprising initiating a transaction process using the user account associated with the authentic identification token if the selected candidate identification token is the authentic identification token.

8. The method of claim 1 wherein the one or more non-authentic identification tokens are pseudo-randomly generated.

9. The method of claim 1 wherein the list of candidate identification tokens includes a greater number of non-authentic identification tokens than authentic identification tokens.

10. The method of claim 1 wherein receiving a request to conduct a transaction and providing a user interface to a user in response to the request, wherein the user interface includes a list of candidate identification tokens, wherein the list of candidate identification tokens includes an authentic identification token and one or more non-authentic identification tokens, wherein the authentic identification token is associated with a user account are performed by one or more software applications stored in one or more computer-readable medium housed in a server computer.

11. An anti-phishing system comprising:
a database comprising of one or more user profiles
a server computer coupled to the database, wherein the server computer comprises a processor and a computer-readable storage medium coupled to the processor, the computer readable storage medium comprising code executable by the processor for implementing a method comprising:
receiving a request to conduct a transaction;
providing a user interface to a user in response to the request, wherein the user interface includes a list of candidate identification tokens, wherein the list of candidate identification tokens includes an authentic identification token and one or more non-authentic identification tokens, wherein the authentic identification token is associated with a user account.

12. The system of claim 11 wherein the user account is a payment card account.

13. The system of claim 12 wherein the authentic candidate identification token is a segment of a payment card number associated with the payment card account.

14. The system of claim 11 wherein the position of the authentic candidate identification token in the list of candidate identification tokens changes position in the list.

15. The system of claim 11 wherein the user interface includes a password field.

16. A method comprising:
requesting to conduct a transaction;
receiving a user interface including a list of candidate identification tokens, wherein the list of candidate identification tokens includes an authentic identification token and one or more non-authentic identification tokens at a user device; and,
selecting an identification token from the list of candidate identification tokens.

17. The method of claim 16 wherein the transaction is a money transfer.

18. The method of claim 16 wherein the transaction is a purchase transaction.

19. The method of claim 16 wherein in response to selecting an authentic identification token from the list of candidate identification tokens, a server computer automatically initiates processing of the transaction.

20. The method of claim 16 wherein the one or more non-authentic identification tokens are pseudo-randomly selected from a pool of non-authentic identification tokens.
